(19) United States
(12) Patent Application Publication
(10) Pub. No.: US 2005/0206033 A1
(43) Pub. Date: Sep. 22, 2005

(54) Solution casting method for producing film

(75) Inventor: Yukihiro Katai, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/068,972

(22) Filed: Mar. 2, 2005

(30) Foreign Application Priority Data
Mar. 19, 2004 (JP) 2004-081281

(51) Int. Cl. B29C 39/00

(52) U.S. Cl. 264/217

(57) ABSTRACT

An inner pressure of a disperser is decreased with use of a vacuum pump. TAC and a mixture solvent are supplied into the disperser. In a dispersion liquid, since the TAC is dispersed to the mixture solvent under the decreased pressure, the content of the gas becomes lower. After the swelling of the dispersion liquid into the swelling solution, the swelling solution is fed to a dope production apparatus so as to obtain a dope. The dope is supplied into a concentrating apparatus for performing the concentration and the degassing of the dope. Thus an obtained condensed dope contains only small quantity of gas components. The dope is thereafter cast from the casting die, dried and cooled to obtain the film. Since the film production was continuously made without using the storing tank, it is prevented that the foreign materials and the gas damage the film properties.

### BACKGROUND OF THE INVENTION

1. Field of the Invention

The present invention relates to a solution casting method for producing a film.

2. Description Related to the Prior Art

Cellulose acylate, especially cellulose triacetate (hereinafter TAC), is used as a material of a film in a solution casting method. The TAC film is used in a liquid crystal display and as a base film of a photosensitive material. In order to produce the TAC film, as described in International Publication under PCT No. 2001-1745 (Pages 2-6), the TAC is dissolved to a mixture solvent, whose main compound is dichloromethane, so as to obtain a polymer solution (hereinafter dope). The dope is cast on a support (for example, a casting belt, a rotary drum and the like) to form a casting film. When having a self-supporting property, the casting film is peeled from the support with support of a peel roller, and dried, cooled, and thereafter wound as a polymer film.

In the prior solution casting method, the dope before the casting onto the support is stored in a storing tank, in which the solvent evaporates. Thus a foreign material called a skinning is generated on the gas-liquid interface, which prevents the formation of the uniform polymer film. Further, the dope fed out from the storing tank is filtrated so as to remove the foreign material, which causes to make the life of a filter shorter. Furthermore, since the storing tank is used, it takes a long time to change the material or the composition of the dope, which decreases the productivity. However, the accumulation time for storing the dope in the storing tank is necessary to make the degassing (defoaming)in the dope.

### SUMMARY OF THE INVENTION

An object of the present invention is to provide a solution casting method in which the deforming treatment for the dope is not necessary.

In order to achieve the object and the other object, in a solution casting method, a polymer is dispersed in a solvent in a vessel, such that a dispersion liquid is obtained. The polymer is dissolved to the solvent, such that a dope may be continuously obtained. The dope is cast to produce a film. Note that the polymer and the solvent may be mixed during the dispersing thereof.

In a preferable embodiment, an absolute pressure in the vessel is decreased so as to be in the range of 10³ Pa to 5×10⁴ Pa. When a standard boiling point of said solvent is T_{b}(° C.), said solvent and said polymer in said vessel has a temperature at least (T_{b}-50)° C. and at most (T_{b}-5)° C. Note that the degassing of the present invention is a process of removing air and gas materials which are in the gas state in a room condition.

Preferably, the polymer swells before dissolving the polymer with keeping the temperature of the dispersion liquid at least (T_{b}-50)° C. and at most (T_{b}-5)° C. Further, the dope is continuously concentrated before casting the dope, and the degassing from the dope is made during the concentrating.

In another solution casting method of the present invention, a dope containing a polymer and a solvent is concentrated, and a degassing from the dope is performed. Then the dope is cast to form a film.

Preferably, non-chlorine type compound is used as the solvent, and the polymer is cellulose acylate, and especially preferably cellulose triacetate.

The dope is cast by a co-casting method or a sequential casting method. The film produced in the present invention is a cellulose acylate film which can be used as a protective film for a polarizing filter and a liquid crystal display in which the polarizing filter is used.

In the above solution casting methods, the dope produced from the polymer and the solvent is not stored but directly fed to the casting die. Since the dispersing of the polymer to the solvent is made under the decreased pressure, the gas compounds are not contained in the dispersion liquid, and therefore the degassing process is not necessary thereafter. Further, after producing the dope, the degassing can be made during the concentrating. Such dope is used for the film production, a uniform casting film is formed, and the production of the film can be stably made for a long time without increase of the filtration pressure. Thus the film has a uniform surface condition and an excellent optical property.

According to the solution casting method of the present invention, as the dispersing of the polymer is made under the decreased pressure, it is not necessary to store in the storing vessel for the degassing from the dope. Accordingly, the film is produced without storing the dope in a storing tank. Therefore, the foreign materials, such as the skinning and the like, are not generated by the evaporation of the solvent, and the produced film is excellent in characteristics of the film surface.

Further, since the degassing can be made during the concentrating of the dope, the voids don't occur in the film production. Therefore the produced film is excellent in characteristics of the film surface. Further, since the dope is concentrated, the dope can have easily the concentration adequate for the film production. Therefore the film produced by the solution casting method of the present invention has a merit in view of the cost.

In another solution casting method of the present invention, since the concentrating and the degassing of the dope is made, the voids don't occur in the film production. Therefore the produced film is excellent in characteristics of the film surface. Further, since the dope is concentrated, the dope can have easily the concentration adequate for the film production. Therefore the film produced by the solution casting method of the present invention has a merit in view of the cost.

Further, since the polymer can be preferably cellulose acylate, particularly cellulose acetate, and particularly cellulose triacetate, the solution casting method of the present invention is adequate for the film production. Further, the film produced by the solution casting method of the present invention does not have the bad surface condition and is excellent in the optical property. Therefore the film can be adequately used as the protective film for a polarizing filter and a liquid crystal display.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a first embodiment of a film production equipment to which a solution casting method of the preset invention is applied;

FIG. 2 is a sectional view of a disperser in the film production equipment;

FIG. 3A is a schematic diagram of a second embodiment of a film production equipment provided with a concentration apparatus, to which a solution casting method of the preset invention is applied;

FIG. 3B is a sectional view of a concentration vessel of the concentration apparatus;

FIG. 4 is a sectional view of an embodiment of a casting die for performing the co-casting

FIG. 5 is a side view of another embodiment of a casting die for performing the co-casting;

FIG. 6 is a sectional view of casting dies for performing a sequential casting.

### PREFERRED EMBODIMENTS OF THE INVENTION

[Polymer]

In the present invention, a polymer is used with a solvent for preparing a dope, and sorts of the polymers are not restricted especially. As the polymer, there is cellulose acylate. In the cellulose acylate, cellulose triacetate having acetylic degree between 57.5% and 62.5% is preferably used. The acetylic degree means the amount of the acetylic acid bound to a unit of weight of cellulose. The acetylic degree is calculated based on a result of measurement of acetylation degree with ASTM:D-817-91. More than 90% of particles of the cellulose acylate have diameter between 0.1 mm and 2 mm. Further, the amount of particles having the diameter between 0.1 mm and 2 mm is preferably more than 95 wt. %, particularly more than 97 wt. %, especially more than 98 wt. %, and most especially more than 99 wt. %. It is preferable that the particles have nearly spherical shape. Further, as the raw material of the cellulose acetate, there are cotton linter and wood pulp. At least one or both of them may be used.

[Solvent]

Sorts of compounds to be used for solvents of the solution is not restricted especially. Concretely, there are non-chlorine type compounds, such as aliphatic hydrocarbons, aromatic hydrocarbons, esters, ketones, ethers, alcohols and the like. In the esters, there are methyl acetate, methylformate, ethylacetate, amylacetate, butylacetate, and the like. In the aliphatic hydrocartons, there a re hexane, n-heptane and the like. In the aromatic hydrocarbons, there are benzene and the like. In the ketons there are acetone, methylethyl ketone, cyclohexanone, and the like. In ethers, there are dioxane, dioxorane, tetrahydrofrane, diethylether, methyl-t-butylether, and the like). In alcohol, there are, for example, methanol, ethanol, n-butanol and the like. Further, hydrocarbone halides may be used, and for example, there are dichloromethane, chlorofolm and the like. In the present invention, the cellulose acylate is dispersed to the solvent. therefore, even if it is designated to use as contents of a mixture solvent the non-chlorine type compounds to which the cellulose acylate has low dissolubility, the dope can be easily obtained. Further, in view of the environmental protection and the cost for treatment for thereof, it is preferable to use the non-chlorine type compound as the main component of a mixture solvent 28.

[Additives]

Further, the additives may be previously dissolved to the solvent used in the present invention for dispersion of the polymer. As the additives, there are plasticizers, UV absorbing agents, matting agents, release agents, deterioration inhibitors, and the like. Note that when the additives are added to the solvent, the additives are directly added to the solvent. Otherwise the additives may be added to other solvent to prepare an additive solution, and thereafter the additive solution may be added to the dispersing solution.

(Plasticizer)

As the plasticizers, for example, there are phosphoric acid esters (for example, triphenyl phosphate, tricresylphosphate, cresyldiphenyl phosphate, octyldiphenyl phosphate, biphenyldiphenyl phosphate, trioctyl phosphate, tributyl phosphate and the like), phthalic acid esters (for example, diethyl phthalate, dimethoxyethyl phthalate, dimethyl phthalate, dioctyl phthalate, and the like), glycolic acid esters (for example, triacetin, tributyrin, butylphthalylbutyl glycolate, ethylphthalylethyl glycolate (hereinafter called also ethylphthalylglycolethyl ester), methylphthalylethyl glycolate, butylphthalylbutylylglycolate and the like), and acetates (for example dipentaerythrithol hexaacetate, ditrimethylol propane tetraacetate, and the like), and the like. However, the plasticers are not restricted in them. Further, the plural sorts of the plasticisers may be used.

(UV Absorbing Agent)

As the ultraviolet (UV) absorbing agent, there are, for example, oxybenzophenone based compounds, benzotriazol based compound, salicylates based compounds, benzophenone based compounds, cyanoacrylate based compounds, nickel complex salt based compounds, and the like. However, the UV absorbing agents are not restricted in them, and plural sorts of the UV absorbing agents may be used.

(Matting Agent)

The matting agents are used for improving a property for preventing a film adhesion under high moisture and a slippery property of the film, and may be inorganic and organic compounds. As inorganic matting agents, there are, preferably, compounds containing silicon, silicon dioxide, titanium oxide, zinc oxide, aluminumoxide, bariumoxide, zirconiumoxide, strontiumoxide, antimony oxide, tin oxide, antimony tin oxide, calcium carbonate, talc, clay, calcined caoline, calcined calcium silicate, calcium silicate hydrate, aluminum silicate, magnesium silicate, calcium phosphate and the like. The particularly preferable matting agent is inorganic compounds containing silicone, and zirconium oxide. However, the especially preferable one is silicone dioxide, since it can decreases the turbidity.

As the organic matting agents, there are polymers, for example, silicone resins, fluoro carbon resins, acryl resins and the like. Particularly preferable is silicone resins, and especially preferable is silicone resins having three dimensional network structure.

(Release Agent)

The release agents have effects to make the peeling force smaller. As the release agent, surface-active agents are especially preferable. There are phosphoric acid type, sulfonic acid type, carboxylic acid type, nonionic type, cationic type and the like in the release agent. However the release agents are not restricted in them. These releasing agents are described in Japanese Patent Laid-Open Publication No. 61-243837. Further, Japanese Paten Laid-Open Publication No. 57-500833 teaches polyethoxylic phosphoric acid ester as release agent. In the Japanese Paten Laid-Open Publication No. 61-69845, the peeling is made in an expenditious way by adding to cellulose ester mono/diphosphoric acid alkylester in which non-esterified hydroxylic group has a free acid form. Further, in Japanese Patent Laid-Open Publication No. 1-299847, a peeling force is decreased by adding inorganic particles and phosphoric acid ester compounds having non-esterified hydroxylic group and propyreneoxide chain.

(Deterioration Inhibitor)

As the deterioration inhibitors, for example, there are antioxidant, peroxide decomposer, radical inhibitor, metal deactivator, acid capture, amine and the like. Further, the UV-absorbing agent is one of the deterioration inhibitors. Such deterioration inhibitors and the above UV-stabilizers are disclosed in Japanese Patent Laid-Open Publication No. 60-235852, 3-199201, 5-1907073, 5-194789, 5-271471, 6-107854, 6-118233, 6-148430, 7-11056, 7-11055, 7-11056, 8-29619, 8-239509 and 2000-204173. The especially preferable deterioration inhibitor is butylized hydroxyl toluene (BHT).

[Solution Casting Method]

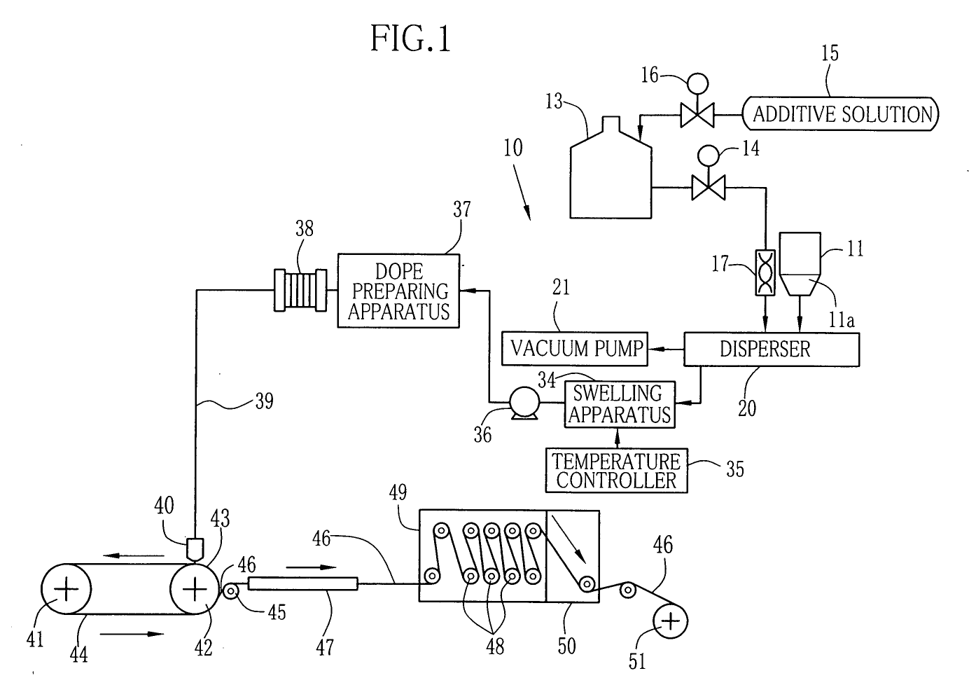

A solution casting method of the present invention is explained with reference to FIG. 1. In the following explanation, although the TAC is used as the polymer, the polymer used in the present invention is not restricted in the TAC.

The TAC in a hopper 11 is supplied to a disperser 20 with measuring and controlling a supplied quantity thereof by a meter 11a. Thereby, about 80 wt. % of the TAC is preferably particles having the averaged diameter from 0.2 mm to 5 mm, and especially 1 mm to 3 mm such that the TAC may easily disperse to the solvent. However, in the present invention, the present invention is not restricted in these ranges. Further, in order to supply the TAC to the dispersion apparatus, a supplying apparatus of a rotary type or a screw type may be used. Further, an inner pressure of the disperser 20 is decreased. Therefore the TAC may be suctioned into the disperser with utilizing the difference between the inner pressure and the atmospheric pressure.

The solvent is contained in a solvent tank 13, and a valve 14 is opened to feed the solvent from the solvent tank 13 to the disperser 20. In this embodiment, the solvent in the present invention is a mixture solution to which an additive solution 15 is previously mixed by opening and closing a valve 16. Preferably, a mixer 17 is disposed between the solvent tank 13 and the disperser 20 for mixing the solvent and the additive solvent 15 uniformly. Note that the mixer 17 is preferably an online static mixer, since it is not necessary in this case to store the mixture solvent 28, in which the solvent and the additive solvent are mixed. However, the present invention is not restricted in it. Note that the mixer 17 is preferably a static mixer of online type, since it is not necessary to store a pre-liquid for the dope.

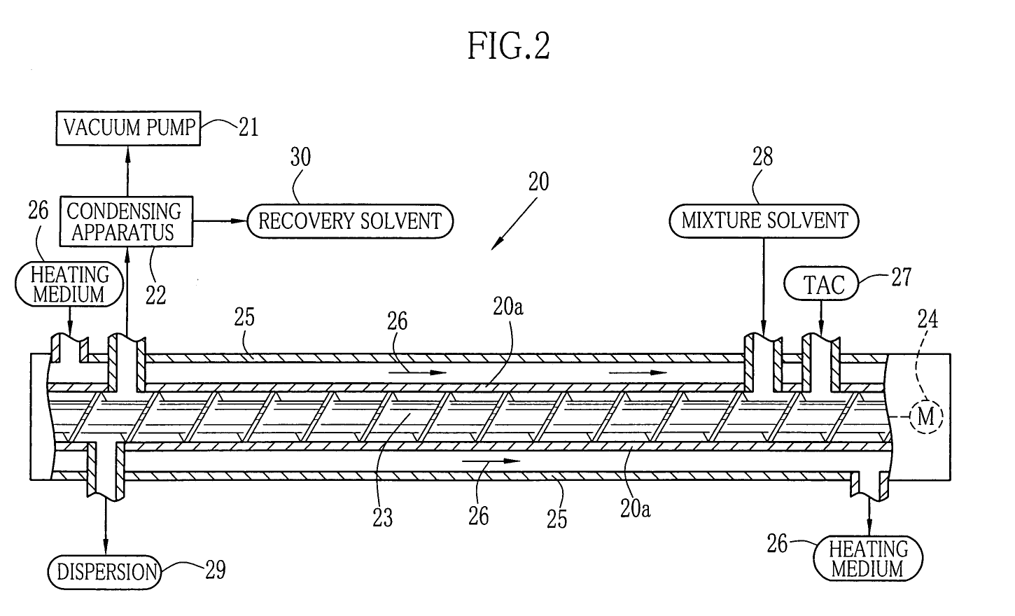

A dispersing method is explained with reference to the disperser in FIG. 2. The disperser 20 has a main body 20a connected through a condensing device 22 to a vacuum pump 21. In the main body 20a, there is a screw connected to a motor 24. Further, so as to cover a periphery of the main body, a jacket 25 is attached. In the jacket 25, a heating medium 26 is supplied for controlling the temperature in the main body 20a of the disperser 20. The heating medium is not restricted especially, but preferably methanol Fluorinart (trade name), brine (trade name) and the like.

The inner pressure in the main body 20a of the disperser 20 is decreased. A difference (hereinafter a decreased value) of the inner pressure to the atmospheric pressure is preferably in the range of 10³ Pa to 5×10⁴ Pa. The decrease of the pressure prevents the air from mixing with or dissolving to the dispersed solution. Further, when it is designated that the decreased value is more than 10³ Pa, it is necessary to use a high vacuum pump, and further to produce the disperser from materials which has pressure capacity under the extremely low pressure. Therefore the cost becomes higher. When the decreased value is less than 5×10⁴ Pa, the defoaming effect sometimes becomes lower. The inner pressure is controlled on the basis of a value measured with use of a pressure gauge (not shown) attached to the disperser 20. While a standard boiling point of the main content of the solvent in a dispersion liquid 29 is a boiling point T_{b}(° C.), the main body 20a is thermally controlled such that the temperature of the dispersion liquid may be preferably at least (T_{b}-50)° C. and at most (T_{b}-5)° C., and especially at least (T_{b}-40)° C. and at most (T_{b}-10)° C. If the temperature is more than (T_{b}-5)° C., the solvent gas generated in the evaporation hardly condensed. Further, if the temperature is less than (T_{b}-50)° C., the enough swelling of undissolved particles in the dispersion liquid in the swelling process becomes harder. Concretely, when dichloromethane whose boiling point is 43° C. is used as the main content of the solvent, the temperature on the inner wall of the main body 20a is preferably from −10° C. to 35° C. When methylacetate whose standard boiling point is 57° C. is used as the main content of the solvent, the temperature on the main body 20a is preferably from 7° C. to 52° C.

With the control of the pressure and the temperarure, the supplied amount of each TAC 27 and the mixture solvent 28 is controlled with use of the meter 11a and a valve 14 (see, FIG. 1). When the TAC 27 and the mixture solvent 28 are supplied to the main body 20a, a screw 23 rotates to make the shearing such that the dispersion liquid of the TAC 27 to the mixture solvent 28 proceeds. Further, in the main body 20a, since the pressure is decreased, the degassing (the removing of voids) is made easily, and the dispersion liquid 29 in which the content of the degassing is made lower. Further, the solvent is concentrated by the condensing device 22 to recovery solvent to be used as the solvent for preparing the dope. Further, when the disperser 20 includes a screw and a jacket, the rotation of the screw causes the generation of heat. Therefore, while the jacket 25 is provided and the heating medium 26 is fed into the jacket 25, the predetermined temperature in the main body 20a is kept.

As described above, in the present invention, when the TAC 27 and the mixture solution 28 are supplied to the disperser 20, the dispersion liquid 29 in which the TAC 27 is uniformly dispersed to the mixture solvent 28 is obtained. Further, in the present invention, since the dispersing is made under the decreased pressure, the gasses or the voids are hardly contained in the dispersion liquid 29.

Preferably, the dispersion liquid 29 is fed into a swelling apparatus 34 for swelling TAC particles, so as to obtain a swelling solution. In this case, the period of producing the dope becomes shorter as described below. The swelling apparatus 34 is provided with a temperature regulator 35 for regulating the temperature of the dispersion liquid 29 in the range of (T_{b}-50)° C. to (T_{b}-5)° C., and especially (T_{b}-40)° C. to (T_{b}-10)° C. (T_{b}(° C.) is the standard boiling point of the main content of the solvent in the dispersion liquid 29, as described above). If the temperature is more than (T_{b}-5)° C., the evaporated solvent hardly condensed. Further, if the temperature is less than (T_{b}-50)° C., the enough swelling of the dispersion liquid in the swelling process becomes harder. Preferably, the dispersion liquid 29 is continuously supplied to the swelling apparatus 34 such that the swelling apparatus 34 may be filled with the dispersion liquid 29. In this case, the gas-liquid interface does not appear, thus it is prevented that the solutes (especially the polymer (TAC)) on an inner wall of the swelling apparatus are solidified, or impurities, called skinning, are not generated. The swelling apparatus 34 may be already known, but is preferably a static mixer such that a storing tank is not necessary.

The swelling solution described above is fed through a pipe to a dope preparing apparatus 37 with use of a pump 36. The dope preparing apparatus 37 produces from the swelling solution the dope used for forming a film. A production method of the dope is not restricted, and may be one of the well-known methods. Concretely, there are a heat-dissolving method, a cool-dissolving method, and a dissolving method in which the dissolution is made in the room temperature. In the followings, the explanations for these three dissolving methods will be made.

(Heat-Dissolving Method)

The swelling solution is heated to a temperature in the range of 60° C. to 240° C. under the pressure from 0.2 MPa to 30 MPa. The temperature range is preferably in the range of 80° C. to 220° C., particularly 100° C. to 200° C., and especially 100° C. to 190° C. In the heating, a high pressure steam, and otherwise an electric source may be used. Further, it is preferable to feed the swelling solution through a pressure tight pipe to a pressure tight vessel. The pressure tight pipe and the pressure tight vessel are made of stainless or iron, but the sorts of the materials are not restricted especially. Further, in order to increase the dissolubility, the swelling solution may be contained at a high temperature under the increased pressure in a tank, within which the carbon dioxide is enclosed. Thus a supercritical solution can be obtained. In this case, the weight ratio between the carbon dioxide and the swelling solution is preferably from 5:95 to 70:30, and especially 10:90 to 60:40.

The dope produced from the swelling solution under the condition of the high pressure and the high temperature is cooled. The cooling temperature is at most the boiling point of the solvent of the dope. Thus the solvent hardly evaporates and the fluctuation of a composition ratio of the dope becomes smaller. Further, when the mixed solvent is used, the lowest boiling point of the compounds in the solvent is determined as a standard value. Further, for easiness of operation, it is preferable that the pressure is made back to the atmospheric pressure with cooling to the range of −10° C. to 55° C. Note that in the cooling, a vessel and pipe (not shown) of the dope preparing apparatus 37 may be disposed in the room temperature, and cooled with use of cooling water as a cooling medium.

In order to improve the solubility in the production of the dope, it is effective to repeat the heating and the cooling. The judgment whether the dope is obtained is made in observation with eyes. Thereby when the cellulose acylate in a gel-like state is not observed, it is judged that the dope is produced. In the heat dissolution, an airtight vessel is used for preventing the fluctuation of the composition ratio caused by the evaporation of the solvent. Note that it is preferable to use the methods described as in Japanese Patent Laid-Open Publications No. 11-322946 and No. 11-322947. However, the heat-dissolving method already known may be used for producing the dope.

(Cool-Dissolving Method)

At first, the swelling solution is cooled to a temperature in the range of −100° C. to −10° C. The cooling temperature is preferably in the range of −100° C. to −30° C., particularly −100° C. to −50° C., and especially −90° C. to −60° C. The cooling is made with a cooling medium, for example a dry ice methanol bath (−75° C.) or a chlorofluorocarbon type cooling medium which is cooled by a cooler and the like. Preferably, the cooling speed is higher. However, it is not especially restricted when the cooling is practically made at a high speed at least about 100° C./sec. Note that in the present invention that the cooling speed is a value obtained by dividing a difference between the temperature at start of the cooling and the predetermined temperature by time period for shift of the temperature from the start value to the predetermined one. The period of cooling at the predetermined temperature is not restricted especially.

The temperature is made higher in the heating after the cooling, the dope is obtained, in which the cellulose acylate flow in the solvent. The temperature becomes higher in the range of 0° C. to 200° C., preferably 0° C. to 150° C., especially 0° C. to 120° C., and more especially 0° C. to 50° C. Note that the temperature may be increased by disposing the vessel for the cooling in the room temperature, by heating in the heating bath, or with use of a heating apparatus. In the increase of the temperature, part of the solvent in the dope (or the swelling solution) evaporates and thus the pressure which is usually in the range of 0.3 MPa to 30 MPa increases. However, in order to make the time period under higher pressure shorter, the heating time for increasing the temperature is preferably in the range of 0.5 minutes to 60 minutes, and especially preferably in the range of 0.5 minutes to 2 minutes.

Note that the cooling and the heating are repeated in this order when the particles are not entirely dissolved even after the one performance of the cooling and the heating. Thus the dope is obtained. In order to judge whether the dope is obtained, the technical worker observes with eyes. Further, when the cool-dissolution is performed, it is preferable to use the tightly closed vessel in the dope preparing apparatus 37, such that the dew concentration water generated in the cooling may not intrude. In the processes of the cooling and the heating, when the pressure in the tightly closed vessel is made higher in the cooling and lower in the heating, the time period for producing the dope can be shorter. The cool-dissolving method described above is preferably made in the manner concretely described in Japanese Patent Laid-Open Publications No. 9-95544 and No. 10-95854. However, the cool-dissolving method is not restricted in the method described in these publications.

(Dissolving Method in Room Temperature)

In the present invention, the dope production method of producing the dope from the swelling solution is not restricted in the above heat-dissolving and cool-dissolving methods. In the followings, the dissolving method in room temperature will be explained. In the dissolving method in room temperature, it is not necessary to use a special devices (for example high speed cooler, pressure tight vessel and the like) in the dope preparing apparatus 37. The temperature of the swelling solution is kept in the range of 0° C. to 55° C., namely in the range of the room temperature ±about 25° C., and the stirring is made enough with the stirrer to produce the dope from the swelling solution. When the swelling solution is stirred, the gel-like materials of cellulose acylate contain the solvent more. Thus the dope is obtained. In the dissolving method in room temperature, the cellulose acylate particle contains the enough quantity of the solvent and dissolves. Therefore, the time period of performing this method must be longer than the other methods. For example the stirring is continuously made for 3 hours. However, in the dissolving method in room temperature, the special devices are not used, the heating temperature is not too high, and the cooling temperature is not too low. Therefore the decomposition of the elements or composition of the swelling solution that is caused in rapid temperature variation is reduced.

Thus the dope is prepared by the dope preparing apparatus 37, and the impurities are removed from the dope by a filtration apparatus 38 connected through a pipe 39 to a casting die 40. Below the casting die 40, there is a casting belt 43 supported by rotary rollers 41,42, and the casting belt 43 is endlessly moved in accordance with the rotation of the rotary rollers 41,42 driven by a driving device (not shown). The dope is cast onto the casting belt with use of the casting die 40, so as to form a casting film (or a gel-like film) 44. While being conveyed by the casting belt 43, the casting film 44 is dried to have a self-supporting property, and peeled as a film 46 from the casting belt by a peeling roller 45.

The film 46 is dried with the transporting by a tenter device (tenter type drying device) 47. It is preferably on this occasion to stretch the film 46 in at least one of width- and lengthwise directions to have a predetermined width. Thus the quality of the film 46 is improved. The film 46 is transported from the tenter device 47 to a drying chamber 49 in which many rollers 48 are provided. The transported film 46 is lapped on the rollers 48 so as to make the drying enough in the drying chamber 46. The film 46 after the drying is cooled in a cooling chamber 50, and wound by a winding apparatus 51. Note that the cooling temperature in the cooling chamber 50 is not restricted especially. However, the cooling temperature is preferably the room temperature for easy treatment. Before the winding, side edge portions of the film 46 transported from the cooling chamber 50 may be cut off, and the knurling may be made. Further, the support is the belt in FIG. 1. However, a rotary drum or the like may be used in the present invention.

As described above, according to the solution casting method of the present invention, since the polymer is dispersed to the solvent and the additives under the decreased pressure to obtain the dispersion liquid, the amount of the gases contained in the dope to be prepared becomes smaller such that the foam may not have bad influences on the film production. In the prior art, in order to remove the gas or the foam thereof from the dope, the dope is usually supplied and stored in the storing tank and the stirring thereof is made for several hours. In the present invention, since there is no process for storing the dope, the generation of the skinning is prevented in an apparatus included in a film production equipment 10.

Preferably, the dope is concentrated to have a predetermined concentration adequate for the casting, and the defoaming (degassing) is made such that the condensed dope may not includes the gasses. Such a concentration apparatus for the concentration may be a continuous concentration apparatus already known. Further, so far as the concentration of the dope is a predetermined value, a degassing apparatus for making the degassing may be a continuous defoaming (degassing) apparatus already known. However, an especially preferable continuous concentration apparatus is a flash-evaporation apparatus with a flush-nozzle, as described in Japanese Patent Laid-Open Publications No. 2002-230362, 2002-230363 and 2002-230364, in which it is prevented that impurities appear in effect of the shift of a surface of the dope.

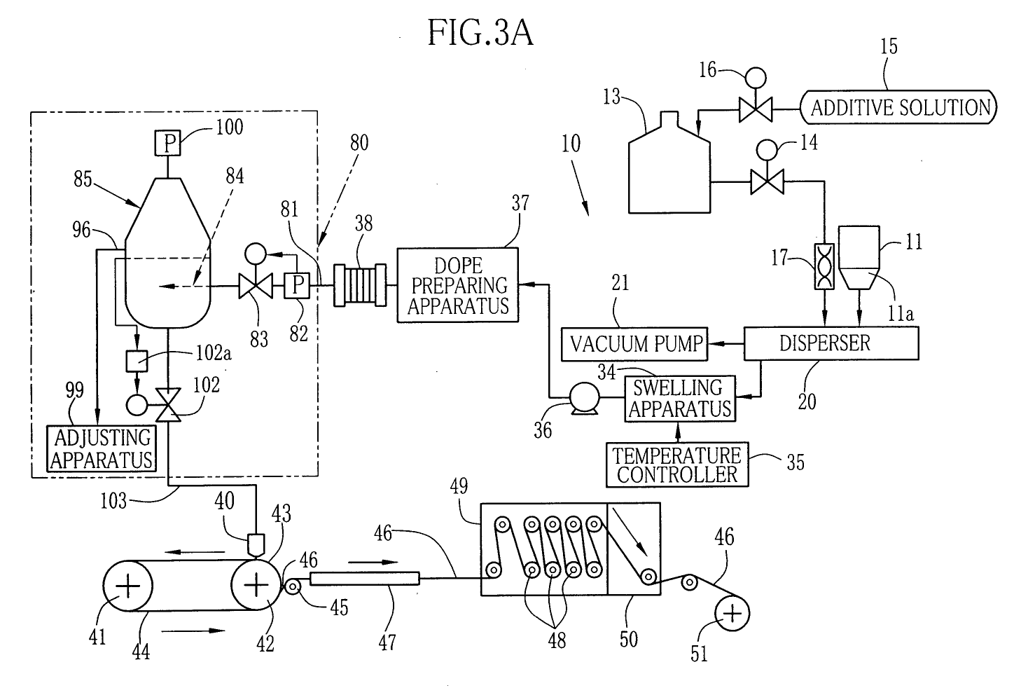

Preferably, as shown in FIG. 3A, a concentration apparatus 80 is connected through a pipe 81 to the filtration apparatus 38, and includes a pressure gauge 82, an adjusting valve 83, a flash nozzle 84 and a main body 85, while the pressure gauge 82, the adjusting valve 83 and the flash nozzle 84 are disposed on the pipe 81. The pressure of the dope fed through the pipe 81 is measured by the pressure gauge 82, and the adjusting valve 83 is opened and closed on the basis of the data of the measurement, so as to control of the flash-pressure at the front end or nozzle end 84a (see, FIG. 3B) of the flash nozzle 84.

As shown in FIG. 3B, the main body 85 of the condensation tank 80 is covered with three jackets 86-88. Each of these jackets 86-88 is provided with a pipe, through which mediums for adjusting temperature are supplied into a space between the main body 85 and each jacket 86-88. Thus the temperature of the main body 85 is controlled. Further, the main body 85 is constructed of a flash section 89 and a condensing section 90. The mediums fed to the jackets 86,87 are heating mediums so as to heat the flash section 89, and the medium fed to the jacket 88 is a cooling medium so as to cool the condensing section 90. The flash section 89 and the condensing section 90 may be integrally produced, and otherwise may be separately produced and thereafter combined to construct the main body 85. Further, it is preferable that the condensing section 90 has an inclined roof. In this case, the concentrated solvent easily flows on the concentration surface downwards in effects of gravity, as described later.

In following, the dope prepared in the dope preparing apparatus 37 is called a prepared dope 92, and the dope after the concentration in the main body 85 is called a condensed dope 93. The prepared dope 92 is supplied from the dope preparing apparatus 37 into the main body 85 containing a concentration dope 91 in the state of the concentration. In the main body 85, the nozzle end 84a is disposed in the concentration dope 91, and the prepared dope 92 fed from the dope preparing apparatus 37 is discharged through the nozzle end 84a into the concentration dope 91 so as to make the flash-evaporation, in which the flash discharge of the prepared dope 92 proceeds the intensive evaporation of the solvent in the concentration dope 91. Thus the composition of the solvent in the concentration dope 91 becomes lower, and the concentration of the polymer becomes higher. The concentration dope 91 having the predetermined concentration is discharged as the condensed dope 93 from the main body 85. Further, the flash-evaporation accelerates the defoaming and the removing the foam compounds and the voids from the concentration dope 91 and the prepared dope 92. The gasses after the degassing is discharged from the main body 85 with the solvent vapor described later. Thus the quantity of the gas in the condensed dope 93 becomes lower or to zero.

The solvent vapor is condensed to a recovery solvent 94b on an inner surface 90a of the condensing section 90. The recovery solvent 94b has a form of drop or extends on the inner surface 90a in the effect of the surface tension of the inner surface 90a. As the inner surface 90a is inclined, the recovery solvent 94b flows downwards in effects of gravity (and surface tension thereof), to be received by a gutter 95, and thereafter flows out from the main body 85 through a pipe 96, and recovered into an adjusting apparatus 99 (see, FIG. 1) for adjusting a concentration of the recovery solvent 94. After the adjustment, the recovery solvent 94 is reused as the solvent for the dope.

A pressure gauge 100 is attached to the main body 85 for measuring an inner pressure of the condensation tank 85. On the basis of valued measured by the pressure gauge 100, the evaporation rate of the flash evaporation of the prepared dope 92 for the flash-evaporation is controlled, and the temperature of the flash section 89 and the condensing section 90 are controlled, so as to keep the inner pressure in the main body 85 constant. A height of a liquid surface 91a of the concentration dope 91 is detected with a liquid surface sensor 101, and data obtained by the liquid surface sensor 101 is sent to a controller 102a, which opens and closes a valve 102 on the basis of the data. Thus the dope having the predetermined concentration for the film production is discharged as the condensed dope 93 from the concentration apparatus 80, which is supplied to the casting die 40 with a control of the flow rate. Note that the processes in the followings are performed under the same conditions as the film production equipment 10 in FIG. 10, and therefore the explanation thereof is omitted.

Usually, at an edge of the liquid surface, foreign materials, such as skinning (not shown) and the like, can be easily appear on the inner wall on which the height of the liquid surface fluctuates. On account of this problem, in the present invention, the heating mediums are fed into the jackets 86, 87 to control the temperature of the inner wall of the main body 85, and thus the temperature of the edge 91b of the liquid surface on the inner wall can be strictly regulated. Therefore, the evaporation of the solvent at the edge 91b of the liquid surface may be reduced, and the generation of the foreign materials, especially the skinning, is prevented. Further, the concentration apparatus 80 continuously concentrate the prepared dope 92 with the defoaming thereof, so as to obtain the condensed dope 93, which is to be used for the film production.

Further, in order to perform the solution casting method, it is preferable that the film production equipment may include both of the disperser 20 and the concentration apparatus 80. In this case, as shown in FIG. 3A, the concentration apparatus 80 may be disposed between the filtration apparatus 38 and the casting die 40 in the film production equipment 10. The explanation of the same conditions and positions will be omitted.

The pressure in the main body 20a of the disperser 20 is decreased, and the TAC 27 and the mixture solvent 28 are supplied into the main body 20a. Then the sharing of the mixture thereof is made to disperse the TAC 27 to the mixture solvent 28. Thereafter the mixture is sent to the swelling apparatus 34. In the swelling apparatus 34, TAC particles are swollen in the mixture solvent 28 so as to obtain the dope easily. However, the process of the swelling can be omitted. The swelling solution is sent to the dope preparing apparatus 37, and the prepared dope 92 is obtained in the heat-dissolving method, the cool-dissolving method, and the dissolving method in the room temperature.

When the prepared dope 92 is discharged from the nozzle end 84a into the main body 85, the flash-evaporation of the solvent is made and the solvent vapor 94a is generated. Thus the concentration of the polymer in the concentration dope 91 becomes higher, and the condensed dope 93 is supplied at the predetermined flow rate through a pipe 103 to the casting die 40 by operating the valve 102. The casting die 40 casts the condensed dope 93 onto the casting belt 43 so as to form a gel-like film 44. Then the gel-like film 44 is peeled as the film 46, which is dried in the tenter device 47 and the drying chamber 49, cooled in the cooling chamber 50, and wound by the winding device 51.

In the above processes, the storing tank for storing the dope or the liquid is not used. Further, the height of the gas-liquid interface does not fluctuate while the film is continuously produced from the raw materials of the dope. Therefore, the skinning of the solute is not generated by evaporating the solvent in the dope. Furthermore, since the dispersion is made under the decreased pressure, the produced dope does not contain the gas compounds. Further, just before the casting of the dope, or in the upstream processes from the film production equipment, the defoaming is simultaneously made in the concentration so as to remove a small quantity of the gas compounds from the liquid (such as the dope and the like). Therefore, it is more effectively prevented that the gas compound is contained in the condensed dope to be cast. Thus the content becomes lower so as to be regarded as zero.

Further, since the concentrating apparatus 80 used in the film production equipment in the present invention can perform the continuous concentration and the continuous degassing, it is not necessary to provide the storing tank for stationary storing the dope or a liquid materials used for preparing it. Further, in the solution casting method of the present invention, the TAC 27 is dispersed to the mixture solvent 28, and thereafter the swelling of the TAC is made. Thus the dope is produced and concentrated by the concentrating apparatus 80. Therefore, the present invention has also an effect that the prepared dope produced by the dope production apparatus can be concentrated to the condensed dope.

[Solution Casting Method for Forming Plural Layers]

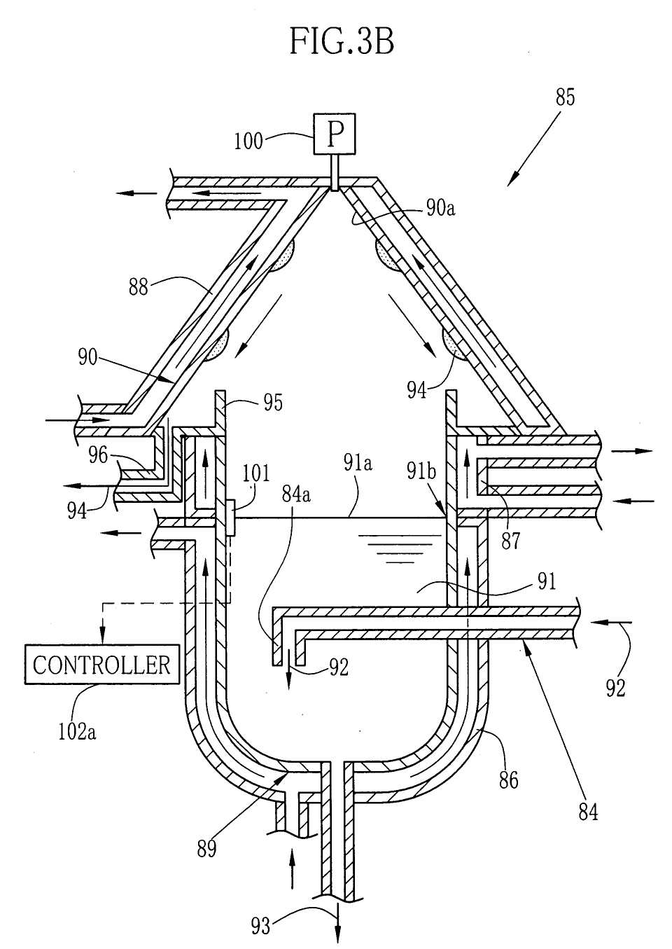

In the above embodiment, the number of the condensed dope cast on the belt is one with used of the casting die 40 for forming a single layer. However, the solution casting method of the present invention is not restricted in it, but for example, may be the solution casting method for forming plural layers. An embodiment of this solution casting method will be explained with a reference to FIGS. 4-6. Note that the explanation and illustration of the same parts and devices will be omitted.

In FIG. 4, a casting die 120 is a multi-manifold casting die having plural manifolds 110, 111, 112 that can be supplied with three different sorts of dopes 114, 115, 116 through feed pipes (not shown). The dopes 114, 115, 116 are joined in a joining portion 117 downstream from the manifolds 110-112 and cast on a band 118 having a three-layer structure to form a gel-like film 119. The gel-like film 119 is dried and thereafter peeled from the band as a polymer film (not shown).

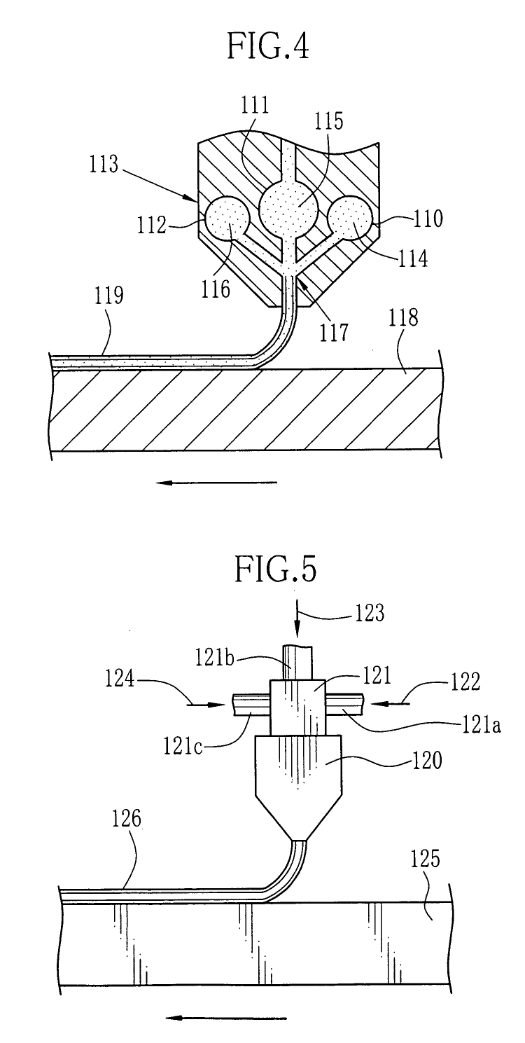

In FIG. 5, a feed block 121 may be provided upstream from a casting die 120. Three pipes 121a-121c are attached to the feed block 121, and the dopes 122, 123, 124 are fed from a feeding device (not shown) through the respective pipes 121a-121c to the feed block 121. The dopes 122, 123, 124 were joined in the feed block 121, and cast on a casting belt 125 by a casting die 120. Thus the casting film 126 is formed on the casting belt 125 and dried to be a film. Note that as the support in FIGS. 4&5, a rotary drum may be used as the casting belt.

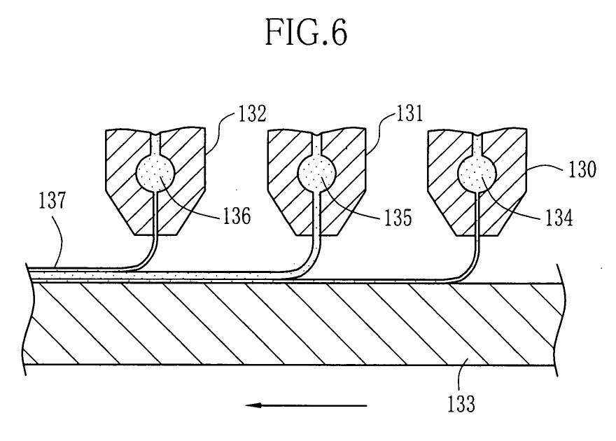

In FIG. 6, three casting dies 130, 131, 132 are arranged above the band 133. The casting dies 130-132 are respectively supplied with dopes 134, 135, 136 through feed pipes (not shown). The dopes 134, 135, 136 are cast on the band 133 sequentially, dried to form a polymer film. It is to be noted in the present invention that this sequential casting method may be combined with that co-casting method.

In each solution casting method for forming the plural layers, at least one of the dispersing under the decreased pressure and the concentrating with the degassing is made so as to prepare the dope used for the casting. This dope is preferably used as at least one of the plural dopes for forming the respective layers, and especially as all of thereof.

The polymer film is cut to obtain ten film samples having size of 5 cm². Each film sample, while being sandwiched between polarized films in cross-nicol position, is observed to know it from the number and size of light point defects, whether the generation of the skinning is reduced. In the present invention, the polymer film is determined to have a good characteristic, when the number of the light point defect having size of at least 20 μm is 0(zero) in the 5 cm² sample, that having size of at least 10 μm and less than 20 μm is the maximum of 10 in 5 cm² sample, or that having size of at least 5 μm and less than 10 μm is the maximum of 10 in 5 cm² sample. In the following, this each criterion is called a quality criterion. Since the film obtained in performance of the present invention satisfies the above range, the film can be used as a base film of the photosensitive material or as a protective film for a polarizing filter.

[Product]

In order to obtain the polarizing filter, the two polymer film can be used for a protective film. When the protective films are adhered to both surfaces of a polarizer formed of polyvinyl alcohol and the like, the polarizing filter is obtained. Further, when the polymer film is adhered to an optical compensation film, then an optical compensatory sheet is obtained as a product. Furthermore, when an antiglare layer is formed on the polymer film, then an optical functional film, for example antireflection film and the like, is obtained as the product. These products can be used for a liquid crystal display.

### EXAMPLE

In the following, an explanation of the example will be made in detail. However, the present invention is not restricted in the example. Further, the explanations of Experiments 1&2 will be made in detail, and the same explanations is omitted in Experiments 3&4.

In Experiment 1, in order to produce the dope, the following compounds were used.

| | | |
|---|---|---|
| Cellulose triacetate particles | 17 | pts. wt. |
| (substitution degree, 2.83; viscosity average | | |
| polymerization degree, 320; water content, 0.4 wt. %; | | |
| viscosity of 6% by mass of dichloromethane solution, | | |
| 350 mPa · s; average diameter of particle, 1.5 mm; | | |
| standard deviation of diameter of particle, 0.5 mm) | | |
| Dichloromethane | 63 | pts. wt. |
| Methanol | 5 | pts. wt. |
| Ethanol | 5 | pts. wt. |
| n-Butanol | 5 | pts. wt. |
| Plasticizer A (dipentaerithritol hexaacetate) | 1.2 | pts. wt. |
| Plasticizer B (triphenylphosphate) | 1.2 | pts. wt. |
| UV-absorbing agent A | 0.2 | pts. wt. |
| (2,4-bis-(n-octylthio)-6-(4-hydroxy-3,5-di-tert- | | |
| butylanylino)-1,3,5-triazine) | | |
| UV-absorbing agent B | 0.2 | pts. wt. |
| (2(2′-hydroxy-3′,5′-di-tert-butylphenyl)-5- | | |
| chrolobenzotriazol) | | |
| UV-absorbing agent C | 0.2 | pts. wt. |
| (2(2′-hydroxy-3′,5′-di-tert-amilphenyl)-5- | | |
| chrolobenzotriazol) | | |
| C₁₂H₂₅OCH₂CH₂OP(═O)(OK)₂ | 0.4 | pts. wt. |
| Particles | 0.05 | pts. wt. |
| (silica-particles having diameter, 20 nm; Mohrs | | |
| hardness, about 7) | | |

For the film production, the film production equipment 10 in FIG. 1 was used. Note that he filtration apparatus 38 and the casting die 40 were connected with the pipe 39. The additive solution 15 was prepared, and mixed with the mixted for the preparation of the dope. Thus the mixture solvent 28 was obtained. The pressure in the main body 20a of the disperser 20 was decreased to about 1×10⁴ Pa, and the heating medium 26 at 20° C. was cyclically fed into the jacket 25. The supply speed of the TAC 27 and the mixture solvent 28 was adjusted so as to obtain the dispersion liquid 29 at 10 kg/min.

The temperature of the feed path (not shown) in the swelling apparatus 34 is controlled to 20° C. by the temperature regulator 35. The dispersion liquid 29 is fed to the swelling apparatus 34 such that the TAC may swell to obtain the swelling solution, which is fed to the dope preparing apparatus 37 and heated to 100° C. therein. Then the dope was prepared by the heat-dissolving method. The dope is filtrated by the filtration apparatus 38 in which advantec #63 (produced by Toyo Roshi Kaisha Ltd.). Thereafter, the dope was fed to the casting die 40.

The dope at 35° C. is cast onto the casting belt 43 moving by the rollers 41,42 at 20° C., such that the thickness of the dried film 46 may be 80 μm. The casting speed was 30 m/min. After the gel-like film 44 has the self-supporting property on the casting belt 43, the film 46 was peeled with support of the peeling roller 45, and then drawn by the tenter device 47 with drying at 120° C. so as to be 130% as large as before the drawing. Further, the film 46 was transferred into the drying chamber 49 in which the temperature was controlled in the range of 110° C. to 140° C. In the drying chamber 49, the film was wound by the rollers 48.

Then the winding of the film 46 was transported with guide of the rollers 48. Then the film 46 was transported into the cooling chamber 50 such that the temperature of the film 46 may be 25° C. Then the film 46 was wound by the winding apparatus 51. The produced film 46 satisfied the quality criterion.

In Experiment 2, in order to produce the dope, the following compounds were used.

| | | |
|---|---|---|
| Cellulose triacetate particles | 15 | pts. wt. |
| (substitution degree, 2.82; substitution degree of | | |
| the acetyl group for hydroxyl group at 6^{th} position, | | |
| 0.95; 32.2% in total acetyl groups was substituted | | |
| for the hydroxyl group at 6^{th} position; viscometric | | |
| average degree of polymerization, 320; ratio of the | | |
| weight average molecular weight to the number | | |
| average molecular weight, 0.5 with uniform distri- | | |
| bution; moisture content, 0.2% by mass; viscosity | | |
| of 6% by mass in methylelchloride solution, 305 | | |
| mPa · s; averared particle diameter, 1.5 mm; | | |
| standard deviation of diameter of particle, 0.5 mm; | | |
| remaining acetylic acid, at most 0.1% by mass; | | |
| remaining Ca, 0.05% by mass; remaining Mg, 0.007% | | |
| by mass; remaining Fe, 5 ppm; the weight percentage | | |
| of the material extracted with acetone, 11% by mass; | | |
| the haze, 0.08; transparency, 93.5%; glass transi- | | |
| tion temperature, 160° C.; calorific value in | | |
| crystallization, 6.2 J/g). | | |
| Methyl acetate | 58 | pts. wt. |
| Acetone | 5 | pts. wt. |
| Methanol | 6 | pts. wt. |
| n-Butanol | 5 | pts. wt. |
| Plasticizer A | 1 | pts. wt. |
| (ditrimethylolpropane tetraacetate) | | |
| Plasticizer B (triphenyl phosphate) | 1 | pts. wt. |
| Plasticizer C (biphenyl diphenyl phosphate) | 0.2 | pts. wt. |
| Plasticizer D | 0.2 | pts. wt. |
| (ethylphthalylgrycol ethylester) | | |
| UV-absorbing agent a | 0.2 | pts. wt. |
| (2,4-bis-(n-octylthio)-6-(4-hydroxy-3,5-di-tert- | | |
| butylanilino)-1,3,5-triazine) | | |
| UV-absorbing agent b | 0.2 | pts. wt. |
| (2-(2′-hydroxy-3′,5′-di-tert-butylphenyl)-5- | | |
| chrolobenzotriazol) | | |
| UV-absorbing agent c | 0.2 | pts. wt. |
| (2-(2′-hydroxy-3′,5′-di-tert-amilphenyl)-5- | | |
| chrolobenzotriazol ) | | |
| Particles | 0.05 | pts. wt. |
| (silica particles having diameter of 20 nm, and Mohrs | | |
| hardness about 7) | | |
| Citric acid monoethyl ester | 0.04 | pts. wt. |

For the film production, the film production equipment 10 was used as in Experiment 1. The additive solvent 15 of the additives was prepared, and mixed with the mixed solvent for the preparation of the dope. Thus the mixture solvent 28 was obtained. The pressure in the main body 20a of the disperser 20 was decreased to about 1×10⁴ Pa, and the heating medium 26 at 25° C. was cyclically fed into the jacket 25. The supply speed of the TAC 27 and the mixture solvent 28 was adjusted so as to obtain the dispersion liquid 29 at 10 kg/min.

The temperature of the feed path (not shown) in the swelling apparatus 34 is controlled to 25° C. by the temperature regulator 35. The dispersion liquid 29 is fed to the swelling apparatus 34 such that the TAC may swell to obtain the swelling solution, which is fed to the dope preparing apparatus 37. The dope was obtained by the cool-dissolving method in the dope preparing apparatus 37. In the cool-dissolving method, the swelling solution was fed with used of a screw pump (not shown) in which a central portion of a screw shaft was heated. A periphery of the screw was cooled to −80° C. and the swelling solution was fed in the screw pump for 20 minutes so as to be the dope. Thereafter, the dope was heated to 40° C., filtrated by the filtration apparatus 38 to remove the impurities, and then fed to the casting die 40. The dope was cast by the casting die 40 under the same conditions as Experiment 1. The produced film 46 satisfied the quality criterion.

Also in Experiment 3, the film production equipment 10 in FIG. 1 was used. Note that the concentration apparatus 80 was disposed between the filtration apparatus 38 and the casting die 40 in the film production equipment 10. The dispersing, the swelling, and the producing of the dope were made under the same condition as Experiment 1.

In the dope preparing apparatus 37, the dispersion liquid 29 was heated to 100° C., and the dope was produced by the heat-dissolving method, and filtrated by the filtration apparatus 38 in which advantec #63 (produced by Toyo Roshi Kaisha Ltd.). The pressure of the dope at 90° C. was measured by a pressure gauge 82, and the valve 83 is opened and closed on the basis of the measured value, such that the prepared dope was discharged from the flush nozzle at 1 MPa of the pressure of the prepared dope to make the flash-evaporation. Note that the predetermined amount of the concentration dope 91 was previously contained in the main body 85. Further, the condensed dope 93 with 25 wt. % polymer concentration was continuously fed to the casting die with opening and closing the valve 102. Note that the film production was made under the same condition as Experiment 1. The produced film 46 satisfied the quality criterion.

In Examination 4, the same film production equipment 10 was used as in Experiment 3. The dope was produced from the dispersion liquid 29 by the cool-dissolving method with use of the dope preparing apparatus 37. With opening and closing the adjusting valve 83 automatically, the dope at 120° C. under 1 MPa was discharged from the flash nozzle 84 so as to make the flash-evaporation. Thereafter, the condensed dope 93 with 23 wt. % polymer concentration was continuously fed to the casting die with opening and closing the valve 102. Note that the film production was made under the same condition as Experiment 1. The produced film 46 satisfied the quality criterion.

Various changes and modifications are possible in the present invention and may be understood to be within the present invention.

1. A solution casting method of casting a dope containing a polymer and a solvent for producing a continuous film, comprising steps of:
continuously dispersing said polymer to said solvent under a decreased pressure in a tank, so as to obtain a dispersion liquid; and
dissolving said polymer to said solvent so as to obtain said dope from said dispersion liquid.

2. A solution casting method as claimed in claim 1, wherein absolute pressure in said vessel is decreased so as to be in the range of 10³ Pa to 5×10⁴ Pa.

3. A solution casting method as claimed in claim 1, wherein when a normal boiling point of said solvent is T_{b}(° C.), a temperature of said solvent in said vessel is in the range of (T_{b}-50)° C. to (T_{b}-5)° C.

4. A solution casting method as claimed in claim 3, further comprising a step of:
swelling said polymer before dissolving said polymer with keeping the temperature of said dispersion liquid at least (T_{b}-50)° C. and at most (T_{b}-5)° C.

5. A solution casting method as claimed in claim 1, further comprising:
continuously concentrating said dope before casting said dope; and
performing a defoaming from said dope during the concentrating.

6. A solution casting method as claimed in claim 5, wherein the dispersing, the dissolving, the concentrating and the casting are sequential.

7. A solution casting method as claimed in claim 1, wherein a non-chlorine type compound is used as said solvent.

8. A solution casting method as claimed in claim 1, wherein said polymer is cellulose acylate.

9. A solution casting method, comprising steps of:
continuously concentrating a dope containing a polymer and a solvent;
performing a degassing from said dope; and
continuously casting said dope to form a film.

10. A solution casting method as claimed in claim 9, wherein a non-chlorine type compound is used as said solvent.

11. A solution casting method as claimed in claim 9, wherein said polymer is cellulose acylate.
